(19) United States
(12) Patent Application Publication
(10) Pub. No.: US 2013/0173460 A1
(43) Pub. Date: Jul. 4, 2013

(54) APPARATUS AND METHOD FOR SHARING CONTENT INFORMATION IN A COMMUNICATION SYSTEM AND A SYSTEM THEREOF

(71) Applicant: SAMSUNG ELECTRONICS CO., LTD., Gyeonggi-do (KR)

(72) Inventors: Dong-Yul LEE, Gyeongsangbuk-do (KR); Jeong-Wook SEO, Daegu (KR)

(73) Assignee: SAMSUNG ELECTRONICS CO., LTD., Gyeonggi-do (KR)

(21) Appl. No.: 13/724,186

(22) Filed: Dec. 21, 2012

(30) Foreign Application Priority Data
Dec. 28, 2011 (KR) 10-2011-0144479

(51) Int. Cl. H04L 29/08; G06Q 20/22

(52) U.S. Cl. CPC H04L 67/104; G06Q 20/22
USPC 705/39; 709/206

(57) ABSTRACT

A method for sharing content information in a communication system includes transmitting a content payment request message to a content providing server, if a payment of a specific content is requested from a user of a first portable terminal, transmitting content information with regard to the specific content in response to the content payment request message to the first portable terminal and a content information registration server, receiving the content information and databasing the received content information, transmitting a content sharing message with regard to the specific content to the first portable terminal, if a wireless communication with the first portable terminal is available, detecting the content information among the databased content information and transmitting the detected content information to a second portable terminal, when the content sharing request message is received; and receiving and storing the content information in response to the content sharing request message.

### CLAIM OF PRIORITY

This application claims, pursuant to 35 U.S.C. §119(a), priority to and the benefit of the earlier filing date of a Korean Application Serial No. 10-2011-0144479, which was filed in the Korean Intellectual Property Office on Dec. 28, 2011, the entire contents of which are hereby incorporated by reference.

### BACKGROUND OF THE INVENTION

1. Field of the Invention

The present invention relates generally to a communication system, and more particularly to an apparatus and a method for sharing content information in a communication system, and a system thereof.

2. Description of the Related Art

In general, a method for advertising content includes online advertising and offline advertising. In particular, the online advertising includes advertising content using a web banner on a website, advertising content using a pop-up advertisement in a portable terminal, or the like.

However, these online advertising methods provide an advertisement to many and unspecified persons regardless of their interest on the content, so there is a problem in that the efficiency of the advertisement decreases.

In order to solve the problem, there has been a need for maximizing the efficiency of the content advertisement.

### SUMMARY OF THE INVENTION

The present invention provides apparatuses, methods, and systems for sharing content information among portable terminals in order to enhance the efficiency of the content advertisement.

In order to solve the problems above, an aspect of the present invention provides a system for sharing content information in a communication system. The system including: a content providing server that transmits the content information to a first portable terminal and a content information registration server, when a content payment request message with regard to a specific content is received from the first portable terminal; the first portable terminal that transmits the content payment request message according to a payment request of a user, receives the content information from a second portable terminal in response to the content payment request message, databases the received content information, detects the content information among the databased content information, when a content sharing request message with regard to the second portable terminal is received, and transmits the detected content information to the second portable terminal; and the second portable terminal transmits the content sharing request message to the first portable terminal if a wireless communication with the first portable terminal is available, and receives and stores the content information in response to the content sharing request message.

In order to solve the problems above, another aspect of the present invention provides an apparatus for sharing content information in a communication system. The apparatus includes: a memory unit; and a controller that transmits a content payment request message to a content providing server when a payment of a specific content is requested by a user, receives content information with regard to the specific content in response to the content payment request message, databases the received content information, and detects the content information among the databased content information, when a wireless communication with a second portable terminal is available, if a content sharing request message with regard to the specific content is received from the second portable terminal.

In order to solve the problems above, another aspect of the present invention provides another apparatus for sharing content information in a communication system. The apparatus includes: a memory unit, and a controller which transmits a first content sharing request message to a first portable terminal, when a wireless communication with the first portable terminal that stores databased content information is available, if sharing of the content information with regard to a specific content by a user is requested, and receives and stores the content information in response to the first content sharing request message.

In order to solve the problems above, the present invention provides a method for sharing content information in a communication system. The method includes: transmitting a content payment request message to a content providing server, if a payment of a specific content is requested from a user of a first portable terminal; transmitting content information with regard to the specific content in response to the content payment request message to the first portable terminal and a content information registration server; receiving the content information and databasing the received content information; transmitting a content sharing message with regard to the specific content to the first portable terminal, if a wireless communication with the first portable terminal is available; detecting the content information among the databased content information and transmitting the detected content information to a second portable terminal, when the content sharing request message is received; and receiving and storing the content information in response to the content sharing request message.

In order to solve the problems above, the present invention provides another method for sharing the content information in the communication system. The method includes: transmitting a content payment request message to a content providing server, when a payment of a specific content is requested from a user; databasing the received content information in response to the content payment request message and receiving content information with regard to the specific content; detecting the content information among the databased content information and transmitting the detected content information, if a wireless communication with a second portable terminal is available, if a content sharing request message with regard to the specific content from the second portable terminal is received.

In order to solve the problems above, in accordance with another aspect of the present invention, a method for sharing content information in a communication system is provided. The method includes transmitting a content sharing request message to a first portable terminal, when a wireless communication with a first portable terminal that stores databased content information is available, when sharing of content information with regard to a specific content is requested by a user and receiving and storing the content information in response to the first content sharing request message.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a configuration of a communication system according to a first exemplary embodiment of the present invention;

FIG. 2 is a block diagram illustrating a configuration of a first portable terminal according to the first exemplary embodiment of the present invention;

FIG. 3 is a diagram illustrating a file structure of content information according to the first exemplary embodiment of the present invention;

FIG. 4 is a block diagram illustrating a second portable terminal according to the first exemplary embodiment of the present invention;

FIG. 5 is a flowchart illustrating a process in which the content information is shared among portable terminals according to a second exemplary embodiment of the present invention;

FIG. 6 is a flowchart illustrating a process in which the first portable terminal shares the content information according to the first exemplary embodiment of the present invention;

FIG. 7 is a flowchart illustrating a process in which the second portable terminal shares the content information according to the first exemplary embodiment of the present invention;

FIG. 8 is a flowchart illustrating a process in which the content information is shared among portable terminals according to the second exemplary embodiment of the present invention;

FIG. 9 is a flowchart illustrating a process in which the first portable terminal shares the content information according to the second exemplary embodiment of the present invention; and

FIG. 10 is a flowchart illustrating a process in which the second portable terminal shares the content information according to the second exemplary embodiment of the present invention.

### DETAILED DESCRIPTION OF THE INVENTION

Hereinafter, various exemplary embodiments of the present invention will be described with reference to the accompanying drawings. Further, in the following description of the present invention, a detailed description of known functions and configurations incorporated herein will be omitted when it may make the subject matter of the present invention rather unclear. The present invention may, however, be embodied in many different forms and should not be construed as limited to the exemplary embodiments set forth herein. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

The same reference numbers are used throughout the drawings to refer to the same or like parts. Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, the term “database” may be used as a verb to denote that data or information are stored in a database.

Among terms set forth herein, data refers to any kind of information processed by the device, including text and/or images received from any external entities, messages transmitted or received, and information created when a specific function is executed by the device.

A portable terminal according to the exemplary embodiments of the present invention is an electronic apparatus which may include a video phone, a cellular phone, a smart phone, an International Mobile Telecommunication 2000 (IMT-2000) terminal, a WCDMA terminal, a Universal Mobile Telecommunication Service (UMTS) terminal, a Personal Digital Assistant (PDA), a Portable Multimedia Player (PMP), a Digital Multimedia Broadcasting (DMB) terminal, an E-Book terminal, a portable computer such as an electronic notebook, an electronic tablet, or the like, a digital camera, or any other known electronic apparatus.

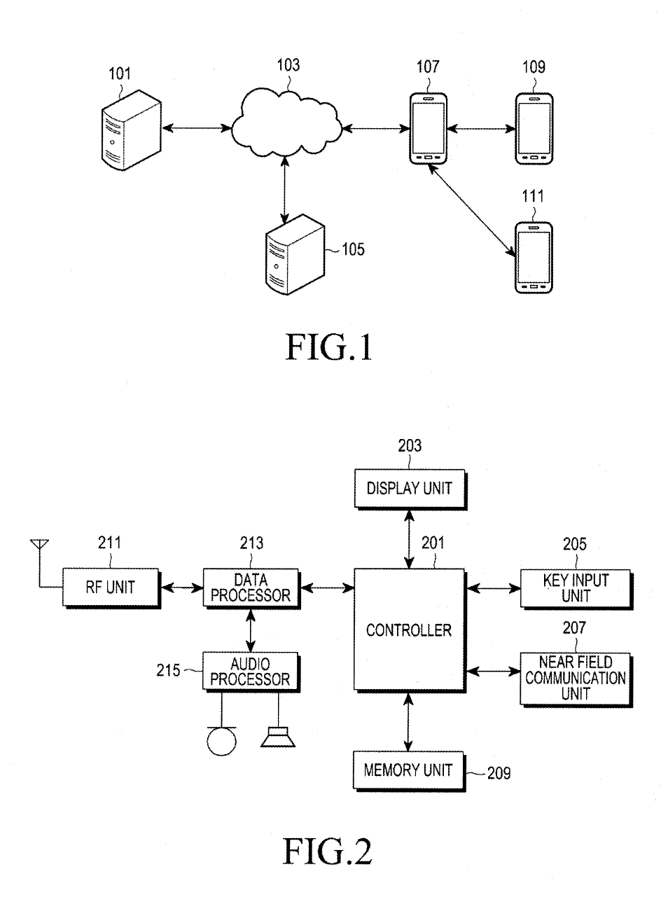

FIG. 1 is a drawing illustrating a configuration of a communication system according to a first exemplary embodiment of the present invention.

With reference to FIG. 1, the communication system includes a content providing server 101, a network 103, a content information registration server 105, and at least portable terminals 107, 109, and 111, including at least a first portable terminal 107, a second portable terminal 109, and a third portable terminal 111.

Each component is described as follows. The content providing server 101 provides content information to the first portable terminal 107 and the content information registration server 105, receives content sharing frequency information from the content information registration server 105, and stores the received content sharing frequency information.

In more detail, when the first portable terminal 107 requests a payment of a specific content and a transmission of a specific content information, the content providing server 101 detects content information corresponding to the specific content and transmits the detected content information to the first portable terminal 107. Further, the content providing server 101 transmits the detected content information to the content information registration server 105, receives content sharing frequency information that includes the number of times of sharing the content information with regard to the specific content from the content information registration server 105, and stores the received content sharing frequency information.

Here, the content information refers to information relating to contents, and may include a content type, a content ID, a company ID, a seller ID, a content ID, a coupon type, and other types content information and details about contents.

As described herein, the content type refers to a type of the content of which the payment or the transmission of the content information is requested by a user of the first portable terminal 107. For example, the content type may be any one of clothes, accessories, handbags, shoes, MP3 files, Digital Video Discs or Digital Versatile Discs (DVDs), and the like. In addition, the content ID refers to an identification (ID) or identifier of a specific content, the company ID refers to an ID of the content manufacturer, and the seller ID refers to an ID of the content seller. In addition, the coupon type refers to a type of the coupon related to the content and provided by the seller or the manufacturer. For example, the coupon type may be a clothes discount coupon, an accessory discount coupon, a handbag discount coupon, a shoe discount coupon, an MP3 file discount coupon, a DVD discount coupon, and the like. In addition, the other content information refers to other information of the content, and may include image files or video files of the content and text files that contains the manufacturer of the contents, the site address of the seller, or any other known types of information of the content.

The content sharing frequency information may include the number of times the content information transmitted to the first portable terminal 107 is shared with other portable terminals, for example, the second portable terminal 109 and the third portable terminal 111. For example, when the content information transmitted to the first portable terminal 107 is shared with the second portable terminal 109 and the third portable terminal 111, the content sharing frequency information may include the number of times of sharing as two times.

The network 103 transmits content information received from the content providing server 101 to the first portable terminal 107 or the content information registration server 105, and transmits content sharing frequency information received from the content information registration server 105 to the content providing server 101.

The first portable terminal 107 receives the content information with regard to a specific content from the content providing server 101 and shares the received content information with other portable terminals 109 and 111.

Meanwhile, the first portable terminal 107 may share content information in two ways: a first way for directly sharing content information and a second way for indirectly sharing content information.

The first portable terminal 107 may share content information directly by having an available and/or established communication path or channel with one or more other portable terminals 109, 111 requesting such content information to be shared. The direct communication path or channel may be in the form of wireless communications between the first portable terminal 107 and the other portable terminals 109, 111.

On the other hand, the first portable terminal 107 may share content information indirectly when a communication path or channel, such as wireless communications, are not available with one or more other portable terminals 109, 111 searching for such content information to be shared. As described herein, such indirect sharing may be performed by the other portable terminals 109, 111 communicating with, for example, the content information registration server, which is performed, for example, by transmitting content sharing request messages.

First, the first way is described in more detail. When the payment of the specific content is requested by the user, the first portable terminal 107 transmits a content payment request message to the content providing server 101 through the network 103. In addition, the first portable terminal 107 receives content information with regard to the specific content in response to the content payment request message.

The first portable terminal 107 databases the received content information in consideration of a content type of a specific content, manufacturer information, seller information, a purchase date, a purchase price, a use frequency, a sharing frequency, and a current use. In addition, the first portable terminal 107 transmits purchase information with regard to the specific content to the content information registration server 105.

Here, the purchase information may include a content type of a specific content, a content ID, a purchase date, and a purchase price.

The first portable terminal 107 confirms whether a first content information sharing request message is received from a second portable terminal 109. Here, the first content information sharing request message is a message for requesting content information with regard to the specific content, and may include a content type and a content ID with regard to the specific content.

Further, when first content information sharing request message is received, the first portable terminal 107 detects the corresponding content information requested to be shared from the databased content information, and transmits the detected corresponding content information to the second portable terminal 109. At this time, the first portable terminal 107 may search content information with regard to the specific content by using the content ID included in the content information sharing request message.

The first portable terminal 107 updates the number of times of sharing the content, and transmits the content sharing frequency information including the updated number of times of sharing the content to the content information registration server 105.

The second way is described in more detail. When the payment of the specific content is requested, the first portable terminal 107 transmits the content payment request message to the content providing server 101 via the network 103. In addition, the first portable terminal 107 receives content information with regard to the specific content in response to the content payment request message.

The first portable terminal 107 databases the received content information in consideration of a content type of a specific content, manufacturer information, seller information, a purchase date, a purchase price, a use frequency, and a current use. In addition, the first portable terminal 107 transmits purchase information with regard to the specific content to the content information registration server 105.

After the specific content information is shared between the second portable terminal 109 and the content information registration server 105, a first portable terminal 109 receives content sharing frequency information from the content information registration server 105, and updates the number of times of sharing the content with regard to the specific content based on the received content sharing frequency information.

The content information registration server 105 receives the content information with regard to the specific content from the content providing server 101 and shares the received content information with other portable terminals 109 and 111.

First, the first way is described in more detail. The content information registration server 105 receives the content information with regard to the specific content from the content providing server 101, receives the content information on the specific content, receives purchase information with regard to the specific content, and registers the content information with regard to the specific content based on the received content information and the purchase information.

After the content information with regard to the specific content is shared between the first portable terminal 107 and the second portable terminal 109, the content information registration server 105 receives content sharing frequency information including the number of times of sharing with regard to the specific content information from the first portable terminal 107, and updates the number of times of sharing with regard to the specific content based on the received content sharing frequency information.

The content information registration server 105 transmits the content sharing frequency information including the updated number of times of sharing to the content providing server 101.

The second way is described in more detail. The content information registration server 105 receives content information with regard to the specific content from the content providing server 101, receives purchase information with regard to the specific content from the first portable terminal 107, and registers the content information with regard to the specific content based on the received content information and the purchase information.

The content information registration server 105 confirms whether a second content information sharing request message for requesting the sharing of the specific content information is received from the second portable terminal 109. Here, the second content information sharing request message may include, for example, images of the specific content.

If the content information registration server 105 receives the second content information sharing request message, the content information registration server 105 detects the corresponding content information requested to be shared from the registered content information, and transmits the detected corresponding content information to the second portable terminal 109. At this time, the content information registration server 105 may search for the corresponding content information from the registered content information based on, for example, the images of the specific content, which may be from the received request message. However, the content information registration server 105 may search other data such as other types of media, including audio, video, and text.

The content information registration server 105 updates the number of times of sharing the content indicating the sharing frequency of the specific content, and transmits the content sharing frequency information including the updated number of times of sharing the content to the content providing server 101 and the first portable terminal 107.

The second portable terminal 109 directly or indirectly shares content information stored in the first portable terminal 107.

First, the first way is described in more detail. When the sharing of the content information with regard to the specific content is requested by the user of the second portable terminal 109, the second portable terminal 109 transmits the first content information sharing request message to the first portable terminal 107.

The second portable terminal 109 receives the content information with regard to the specific content and stores the received content information. In addition, the second portable terminal 109 may display the content information stored by the request of the user.

The second way is described in more detail. When the sharing of the content information with regard to the specific content is requested by the user of the second portable terminal 109, the second portable terminal 109 transmits the second content information sharing request message to the content information registration server 105.

In response to the second content information sharing request message, the second portable terminal 109 receives the content information with regard to the specific content and stores the received content information. In addition, the second portable terminal 109 may display the stored content information stored by the request of the user.

FIG. 2 is a block diagram illustrating a configuration of the first portable terminal 107 according to the first exemplary embodiment of the present invention, which also may be the configuration of the other portable terminals 109, 111.

With reference to FIG. 2, the first portable terminal 107 may include a controller 201, a display unit 203, a key input unit 205, a near field communication unit 207 which may be at least a near field wireless communication unit, a memory unit 209, an RF unit 211, a data processor 213, and an audio processor 215 which may be connected to a microphone and/or a speaker.

Each component is described as follows. The RF unit 211 performs wireless communication functions of the portable terminal. In more detail, the RF unit 211 includes a wireless transmitter that performs up-conversion and amplification of the frequency of the transmitted signals, a wireless receiver that performs low noise amplification of the received signals and performs down-converting of the frequency, or the like. In addition, the data processor 213 may include a transmitter that encodes and modulates the received signals, a receiver that demodulates and decodes the received signals, or the like. Here, the data processor 213 may include a modem and a codec. The codec may include a data codec that processes packet data, a video codec that processes video signals, and/or an audio codec that processes audio signals such as voices.

The audio processor 215 reproduces the reception audio signals output from the data processor 213 through the speaker, or transmits the transmission audio signal generated from the microphone to the data processor 213. In addition, the key input unit 205 includes keys for inputting numerical, symbolic, and character information, and function keys for setting various functions, and the display unit 203 displays the video signal on a screen, and displays data requested to be output from the controller 201.

For example, when the display unit 203 is implemented by a touch screen display type such as a capacitive touch screen or a resistive touch screen, the key input unit 205 may include predetermined minimum keys, and the display unit 203 may replace or supplement at least a part of the key input function of the key input unit 205.

The near field communication unit 207 transmits the content information with regard to the specific content to the second portable terminal 109 by using a near field wireless communication function or receives content information from the content providing server 101. For example, a near field wireless communication function may be a near field communication (NFC) function.

The memory unit 209 includes a program memory and a data memory. Here, the program memory stores a booting system and an operating system (hereinafter referred to as an “OS”) for controlling general operations of the portable terminal, and the data memory stores various data generated in the portable terminal operations. In particular, the memory unit 209 stores the content information received from the content providing server 101.

Here, the content information refers to information relating to a content, and may include a content type, a content ID, a company ID, a seller ID, a content ID, a coupon type, and other content information, in detail.

The controller 201 performs a function of controlling the entire operations of the portable terminal. In particular, the controller 201 receives content information with regard to the specific content from the content providing server 101, receives the content information on the specific content, and shares the received content information with the other portable terminals 109 and 111.

Meanwhile, the controller 201 shares the content information in two ways: a first way for directly sharing the content information and a second way for indirectly sharing the content information.

First, the first way is described in more detail. When the payment of the specific content is requested by the user, the controller 201 transmits the content payment request message to the content providing server 101. In addition, the controller 201 receives content information with regard to the specific content in response to the content payment request message.

The controller 201 databases the received content information in consideration of a content type of the specific content, manufacturer information, seller information, a purchase date, a purchase price, a use frequency, a sharing frequency, and a current use. At this point, the controller 201 databases the received content information, for example, in a format as presented in Table 1 below.

TABLE 1

Database Type
Content type
Manufacturer Information
Seller Information
Purchase Date
Purchase Price
Use Frequency
Sharing Frequency
Current Use

Here, the content type refers to a type of the specific content, for example, any one of clothes, accessories, handbags, shoes, MP3 files, DVDs, and the like. In addition, the manufacturer information refers to information on a company that manufactures the specific content and the seller information refers to information on the location where the specific content is sold. In addition, the purchase date indicates a date when the specific content is purchased and the purchase price refers to a price at which the specific content is purchased.

The use frequency refers to the number of times the user of the first portable terminal 107 has used the specific content since a specific point in time, for example, a point in time when the specific content is purchased. The use frequency may be reset by the user. In addition, the sharing frequency refers to the number of times the content information with regard to the specific content is shared with the other portable terminals. In addition, the current use refers to whether the user currently uses the specific content.

When an NFC tag, such as an identifier or a flag in the memory 209, is attached to the specific content, if the NFC tag is recognized using a peer-to-peer (hereinafter, referred to as “P2P”) communication system via the near field communication unit 207, without a specific registration process, the controller 201 determines that the user uses the specific content, and otherwise the controller 201 determines that the user does not use the specific content. According to the determination result, the controller 201 databases the current use with regard to the specific content.

The controller 201 transmits the purchase information with regard to the specific content to the content information registration server 105. Here, the purchase information includes a content type of the specific content, a content ID, a purchase date, and a purchase price.

The controller 201 confirms whether the first content information sharing request message is received from the second portable terminal 109. Here, the first content information sharing request message is a message for requesting the content information with regard to the specific content and may include a content type and a content ID with regard to the specific content.

When the first content information sharing request message is received, the controller 201 detects the corresponding content information requested to be shared from the databased content information and transmits the detected corresponding content information to the second portable terminal 109. At this point, the controller 201 may search the content information with regard to the specific content by using the content ID included in the content information sharing request message.

The controller 201 updates the number of times of sharing the content indicating the sharing frequency of the specific content, and transmits the number of times of sharing the content including the updated content sharing number to the content information registration server 105.

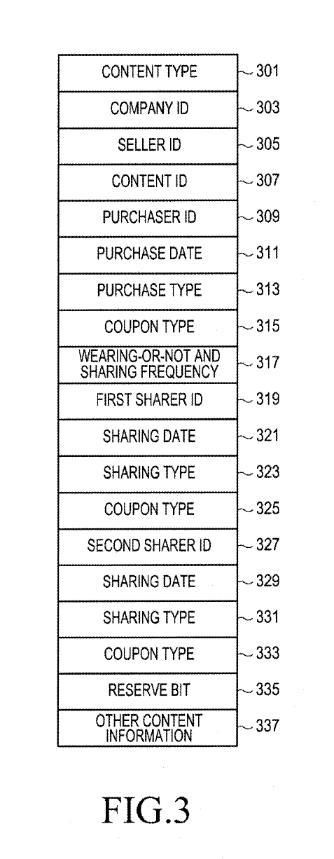

Meanwhile, an example of a file structure of the content information which the controller 201 transmits to the second portable terminal 109 is illustrated in FIG. 3.

With reference to FIG. 3, the content information file includes a content type 301, a company ID 303, a seller ID 305, a content ID 307, a purchaser ID 309, a purchase date 311, a purchase type 313, a coupon type 315, wearing-or-not and sharing frequency 317, a first sharer ID 319, a sharing date 321, a sharing type 323, a coupon type 325, a second sharer ID 327, a sharing date 329, a sharing type 331, a coupon type 333, reserve bits 335, and other content information 337.

Here, the content type 301 refers to a type of the specific content of which the payment is requested by the user of the first portable terminal 107 or a transmission of the content information is requested. For example, the content type 301 may be clothes, accessories, handbags, shoes, MP3 files, DVDs, or the like. In addition, the content type 301 may be configured to be stored in 32 bits.

The content ID 307 refers to an ID of the specific content, the company ID 303 refers to an ID of the content manufacturer, and the seller ID 305 refers to an ID of the content seller. For example, the content ID 307, the company ID 303, and the seller ID 305 are configured to each be stored in 32 bits, respectively.

The purchaser ID 309 refers to an ID of the user who purchased the specific content, the purchase date 311 refers to a date when the specific content is purchased, and the purchase type 313 refers to a type in which the specific content information is purchased. For example, the purchase type 313 may be a cyber money purchase in which the specific content is purchased by cyber money or other known types of electronic financial transactions, an account transfer purchase in which the specific content is purchased by an account transfer, a credit card purchase in which the specific content is purchased by using a credit card, or the like. In addition, the purchaser ID 309 is configured to be stored in 32 bits, the purchase date 311 is configured to be stored 16 bits, and the purchase type 313 is configured to be stored 16 bits.

The coupon type 315 refers to a type of the coupon provided by the seller or the manufacturer in relation to the specific content. For example, the coupon type may be a clothes discount coupon, an accessory discount coupon, a handbag discount coupon, a shoes discount coupon, an MP3 file discount coupon, a DVD discount coupon, and the like. In addition, the coupon type 315 may be configured to be stored in 16 bits.

The wearing-or-not and sharing frequency 317 refers to whether the user wears or uses the specific content and/or the number of times the content information with regard to the specific content is shared with other portable terminals. In addition, the wearing-or-not and sharing frequency 317 may be configured to be stored in 16 bits.

The first sharer ID 319 refers to an ID of a first sharer who shares the specific content information. For example, when the specific content information is shared with the second portable terminal 109, the first sharer ID 319 may be an ID of the second portable terminal 109. Here, the ID of the second portable terminal 109 may be any one of a telephone number and a Media Access Control (MAC) address of the second portable terminal 109. In addition, the first sharer ID 319 may be configured to be stored in 32 bits.

The sharing date 321 refers to a date when the specific content information is shared with the first sharer, and the sharing type 323 refers to a communication method used when the specific content information is shared. For example, the sharing type 323 may be an infrared communication system for sharing the specific content information using an infrared communication, a Bluetooth communication system for sharing the specific content information using a Bluetooth communication, an NFC communication system for sharing the specific content information using an NFC system, a Wi-Fi communication system for sharing the specific content information using a Wi-Fi communication, and a third generation mobile communication system for sharing the specific content information using a third generation mobile communication. In addition, the sharing date 321 and the sharing type 323 may be configured to be stored in 16 bits.

The coupon type 325 refers to a type of the coupon shared with the first sharer among the coupons provided by the seller or the manufacturer in relation to the specific content. For example, the coupon type 325 may be a clothes discount coupon, an accessory discount coupon, a handbag discount coupon, a shoes discount coupon, an MP3 file discount coupon, a DVD discount coupon, or the like. In addition, the coupon type 325 may be configured to be stored in 16 bits.

The second sharer ID 327 refers to an ID of the second sharer who shares the specific content information. For example, when the specific content information is shared with the third portable terminal 111, the second sharer ID 327 may be an ID of the third portable terminal 111. Here, the ID of the third portable terminal 111 may be any one of a telephone number and a MAC address of the third portable terminal 111. In addition, the second sharer ID 327 may be configured to be stored in 32 bits.

The sharing date 329 refers to a date when the specific content information is shared with the second sharer, and the sharing type 331 refers to a communication system used for sharing the specific content information. For example, the sharing type 331 may be an infrared communication system for sharing the specific content information using an infrared communication, a Bluetooth communication system for sharing the specific content information using a Bluetooth communication, an NFC communication system for sharing the specific content information using an NFC system, a Wi-Fi communication system for sharing the specific content information using a Wi-Fi communication, and a third generation mobile communication system for sharing the specific content information using a third generation mobile communication. In addition, the sharing date 329 and the sharing type 331 may be configured to be stored in 16 bits.

The coupon type 333 refers to a type of the coupon shared with the second sharer among coupons provided the seller and the manufacturer in relation to the specific content. For example, the coupon type 333 may be a clothes discount coupon, an accessory discount coupon, a handbag discount coupon, a shoes discount coupon, an MP3 file discount coupon, a DVD (discount coupon, and the like. In addition, the coupon type 333 may be configured to be stored in 16 bits.

The reserve bits 335 are bits which are reserved for adding specific information which may be any known type of information, and the other content information 337 refers to other information of the specific content. For example, the other content information 337 may include image files, audio files, or video files of the content and text files that contain the manufacturer of the contents, the site address of the seller, or information of the content.

The second way is described in more detail. When the payment of the specific content is requested by the user, the controller 201 transmits the content payment request message from the content providing server 101. In addition, the controller 201 receives content information with regard to the specific content in response to the content payment request message.

The controller 201 databases the received content information in consideration of a content type of the specific content, manufacturer information, seller information, a purchase date, a purchase price, a use frequency, a sharing frequency, and a current use. In addition, the controller 201 transmits the purchase information with regard to the specific content to the content information registration server 105.

After the content information on the specific content is shared between the second portable terminal 109 and the content information registration server 105, the controller 201 receives content sharing frequency information from the content information registration server 105, and updates the number of times of sharing with regard to the specific content based on the received content sharing frequency information.

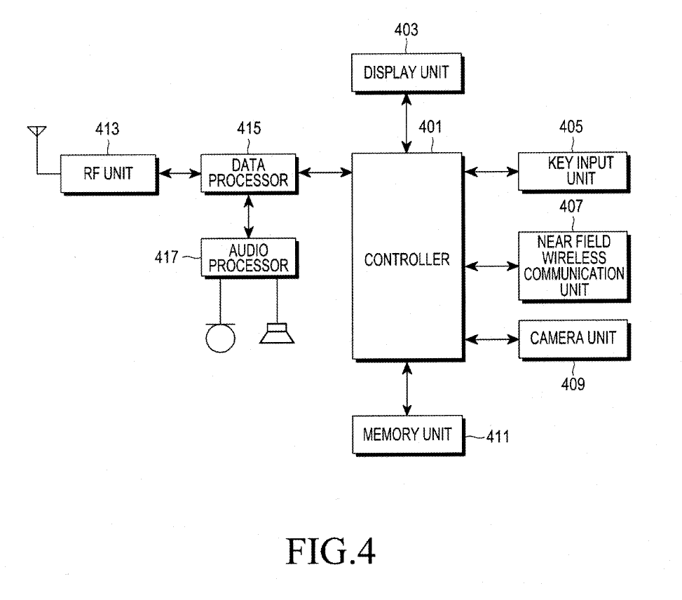

FIG. 4 is a block diagram illustrating a configuration of the second portable terminal 109 according to the first exemplary embodiment of the present invention, which also may be the configuration of the other portable terminals 107, 111.

With reference to FIG. 4, the second portable terminal 109 includes a controller 401, a display unit 403, a key input unit 405, a near field wireless communication unit 407, a camera unit 409, a memory unit 411, an RF unit 413, a data processor 415, and an audio processor 417 which may be connected to a microphone and/or a speaker.

Each component is described as follows. The RF unit 413 performs wireless communication functions of the portable terminal. In more detail, the RF unit 413 includes a wireless transmitter that performs up-conversion and amplification of the frequency of the transmitted signals, a wireless receiver that performs low noise amplification of the received signals and performs down-converting of the frequency, or the like. In addition, the data processor 415 includes a transmitter that encodes and modulates the received signals, a receiver that demodulates and decodes the received signals, or the like. Here, the data processor 415 may include a modem and a codec. The codec may include a data codec that processes packet data, a video codec that processes video signals, and/or an audio codec that processes audio signals such as voices.

The audio processor 417 reproduces the reception audio signals output from the data processor 415 through the speaker, or transmits the transmission audio signal generated from the microphone to the data processor 415. In addition, the key input unit 405 includes keys for inputting numerical, symbolic, and character information, and function keys for setting various functions, and the display unit 403 displays the video signal on a screen, and displays data requested to be output from the controller 401.

For example, when the display unit 403 is implemented by a touch screen display type such as a capacitive touch screen or a resistive touch screen, the key input unit 405 may include predetermined minimum keys, and the display unit 403 may replace or supplement at least a part of the key input function of the key input unit 405.

The near field wireless communication unit 407 receives the content information with regard to the specific content from the second portable terminal 109 by using a near field wireless communication function. For example, a near field wireless communication function may be an NFC function.

The camera unit 409 captures a subject through an image sensor to generate images and outputs the generated images to the controller 401. In particular, the camera unit 409 captures specific content and generates images including the form of the specific content.

The memory unit 411 includes a program memory and a data memory. Here, the program memory stores a booting system and an operating system (hereinafter referred to as an “OS”) for controlling general operations of the portable terminal, and the data memory stores various data generated in the portable terminal operations. In particular, the memory unit 411 stores the content information received from the first portable terminal 109 or the content information registration server 105.

Here, the content information refers to information relating to a content, and may include a content type, a content ID, a company ID, a seller ID, a content ID, a coupon type, and other content information, in detail.

The controller 401 directly or indirectly shares the content information stored in the first portable terminal 107. At this point, the controller 401 shares the specific content information in two ways: a first way for directly sharing the specific content information with the first portable terminal 107 and a second way for indirectly sharing the specific content information with the first portable terminal 107.

First, the first way is described as follows. When the sharing of the content information with regard to the specific content is requested by the user of the second portable terminal 109, the controller 401 transmits the first content information sharing request message to the first portable terminal 107. Here, the first content information sharing request message is a message for requesting the content information with regard to the specific content and may include a content type and a content ID with regard to the specific content.

The controller 401 receives and stores the specific content information with regard to the specific content in response to the first content information sharing request message. In addition, the controller 401 may display the stored content information by a request of the user.

The second way is described as follows. When the sharing of the content information with regard to the specific content is requested by the user of the second portable terminal 109, the controller 401 transmits the second content information sharing request message to the content information registration server 105. Here, the second content information sharing request message may include images of the specific content.

The controller 401 receives the content information with regard to the specific content in response to the second content information sharing request message. In addition, the controller 401 may display the stored content information by a request of the user.

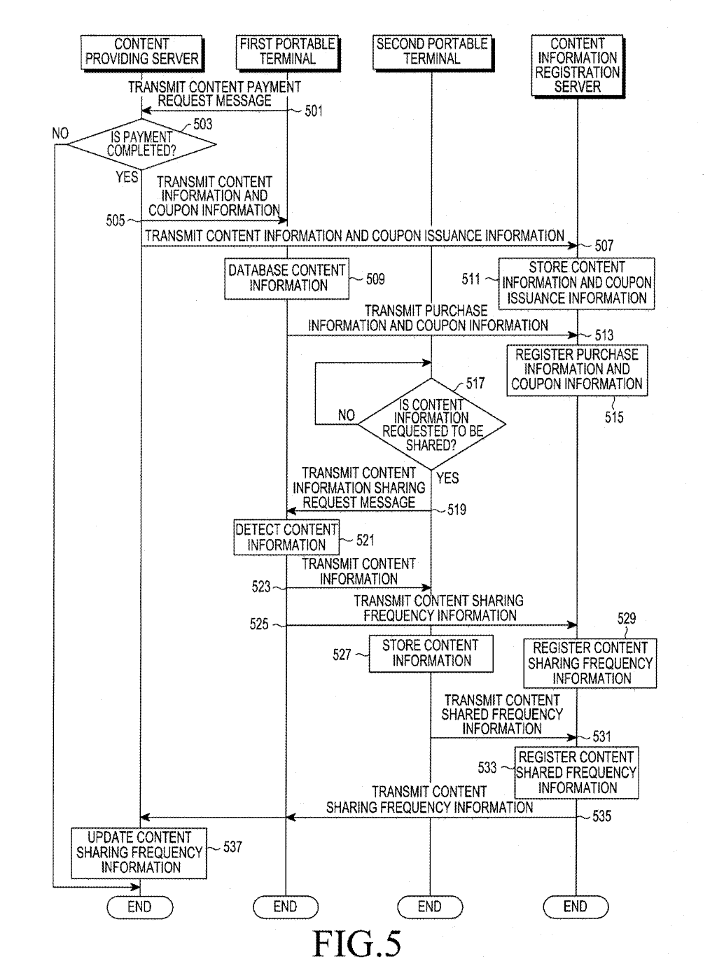

FIG. 5 is a flowchart illustrating a process in which the content information is shared among portable terminals according to a second exemplary embodiment of the present invention. In particular, FIG. 5 is a flowchart illustrating the first way in which the specific content information is directly shared between the first portable terminal 107 and the second portable terminal 109.

With reference to FIG. 5, in Step 501, when the payment of the specific content is requested by the user, the first portable terminal 107 transmits the content payment request message to the content providing server 101 and proceeds to Step 503.

In Step 503, the content providing server 101 confirms whether the payment of the specific content is completed. If the payment of the specific content is completed, the content providing server 101 proceeds to Step 505, or otherwise ends the content sharing process.

If the content providing server 101 proceeds to Step 505, the content providing server 101 transmits the content information and the coupon information to the first portable terminal 107 and proceeds to Step 507. In more detail, the content providing server 101 detects the content information with regard to the paid specific content among the pre-existing content information stored in advance, detects the coupon information corresponds to the paid specific content among coupon information stored in advance, and transmits the detected coupon information to the first portable terminal 107.

In Step 507, the content providing server 101 transmits coupon issuance information indicating that the detected content information and the detected coupon information is transmitted to the content information registration server 105, and proceeds to Step 509. Here, the coupon issuance information may include an ID and a type of the detected coupon.

In Step 509, the first portable terminal 107 databases the received content information in consideration of a content type of the specific content, manufacturer information, seller information, a purchase date, a purchase price, a use frequency, a sharing frequency, and a current use. In Step 511, the content information registration server 105 stores the content information and the coupon issuance information with regard to the specific content.

In Step 513, the first portable terminal 107 generates purchase information with regard to the specific content using the payment information of the specific content, transmits the generated purchase information and the coupon information with regard to the specific content to the content information registration server 105, and proceeds to Step 515. Here, the payment information may include the purchase date and purchase type of the specific content. In Step 515, the content information registration server 105 receives the purchase information and the coupon information, registers the received purchase information and the received coupon information, and proceeds to Step 517.

When the content information registration server 105 proceeds to Step 517, the second portable terminal 109 confirms whether the sharing of the specific content information is requested by the user of the second portable terminal 109. Resulting from such a confirmation, when the sharing is requested, the second portable terminal 109 proceeds to Step 519, or otherwise if no specific content information is requested in step 517, the method loops back and performs Step 517 repeatedly until such information is requested.

If the content information registration server 105 proceeds to Step 519, the second portable terminal 109 transmits the content information sharing request message for requesting the specific content information to the first portable terminal 107, and proceeds to Step 521.

In Step 521, in response to the content information sharing request message, the first portable terminal 107 detects the specific content information from the content information stored in advance, and proceeds to Step 523. In Step 523, the first portable terminal 107 transmits the detected specific content information to the second portable terminal 109, and proceeds to Step 525. In Step 525, the first portable terminal 107 generates, changes, and/or updates the content sharing frequency information indicating that the number of times of sharing with regard to the specific content increases, and transmits the generated content sharing frequency information to the content information registration server 105.

In Step 527, the second portable terminal 109 receives the specific content information, and stores the received specific content information. In Step 529, the content information registration server 105 receives the content sharing frequency information, and registers the number of times of sharing with regard to the specific content according to the received content sharing frequency information.

In Step 531, the second portable terminal 109 generates, changes, and/or updates content shared frequency information indicating that the specific content information is shared, and transmits the generated content shared frequency information to the content information registration server 105. Here, the content shared frequency information may include the ID of the second portable terminal 109 and the content ID with regard to the specific content.

In Step 533, the content information registration server 105 receives the content shared frequency information, registers the received content shared frequency information, and proceeds to Step 535. At this point, the content information registration server 105 registers the ID of the second portable terminal 109 to correspond to the content ID.

In Step 535, the content information registration server 105 transmits the content sharing frequency information with regard to the specific content to the content providing server 101, and proceeds to Step 537. In Step 537, the content providing server 101 receives the content sharing frequency information, and updates the number of times of sharing with regard to the specific content according to the received content sharing frequency information. The method of FIG. 5 then ends.

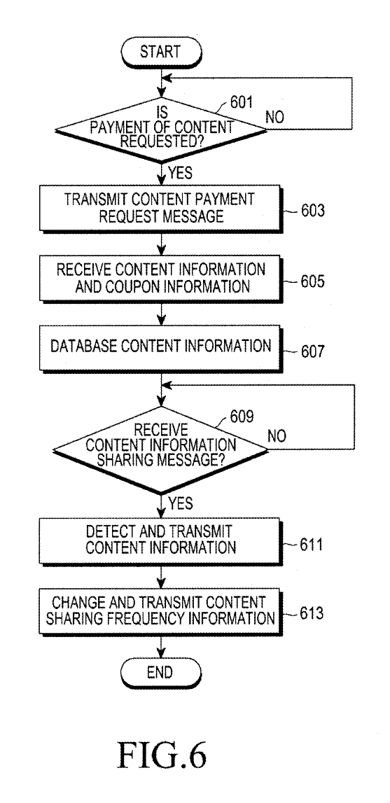

FIG. 6 is a flowchart illustrating a process in which the first portable terminal shares the content information according to the first exemplary embodiment of the present invention. In particular, FIG. 6 is a flowchart illustrating the first way for directly sharing the specific content information between the first portable terminal 107 and the second portable terminal 109.

With reference to FIG. 6, in Step 601, the first portable terminal 107 confirms whether the payment of the specific content is requested by the user. Resulting from the confirmation, if the payment is requested, the first portable terminal 107 proceeds to Step 603, or otherwise, if no request is received in Step 601, the method loops back and proceeds to Step 601, repeatedly until a request is received.

If the first portable terminal 107 proceeds to Step 603, the first portable terminal 107 transmits the content payment request message to the content providing server 101, and proceeds to Step 605. In Step 605, in response to the content payment request message, the first portable terminal 107 receives the content information and the coupon information with regard to the specific content, and proceeds to Step 607.

In Step 607, the first portable terminal 107 databases the received content information in consideration of a content type of the specific content, manufacturer information, seller information, a purchase date, a purchase price, a use frequency, a sharing frequency, and a current use, and proceeds to Step 609.

In Step 609, the first portable terminal 107 confirms whether a content information sharing request message for requesting the specific content information to be shared is received from the second portable terminal 109. Resulting from the confirmation, if the content information sharing request message is received, the first portable terminal 107 proceeds to Step 611, or otherwise if no such request message is received, the method loops back to Step 609 and performs Step 609, repeatedly until such a request message is received.

If the first portable terminal 107 proceeds to Step 611, the first portable terminal 107 detects the specific content information from the databased content information, transmits the detected specific content information to the second portable terminal 109, and proceeds to Step 613.

In Step 613, the first portable terminal 107 generates, changes, and/or updates content sharing frequency information for indicating the number of times of sharing the specific content information, and transmits the changed content sharing frequency information to the content information registration server 105.

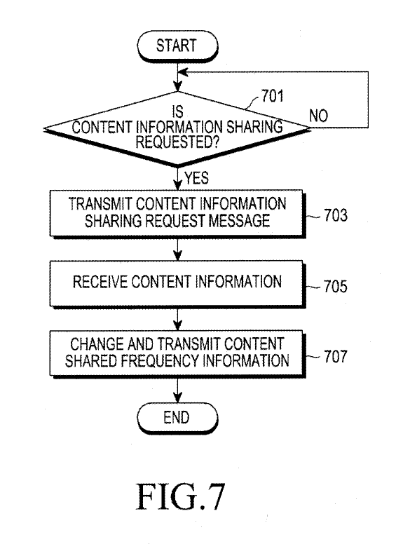

FIG. 7 is a flowchart illustrating a process in which the second portable terminal 109 shares the content information according to the first exemplary embodiment of the present invention. In particular, FIG. 7 is a flowchart illustrating the first way for directly sharing the specific content information between the first portable terminal 107 and the second portable terminal 109.

With reference to FIG. 7, in Step 701, the second portable terminal 109 confirms whether the sharing of the specific content information is requested by the user of the second portable terminal 109. Resulting from the confirmation, if the sharing is requested, the second portable terminal 109 proceeds to Step 703, or otherwise if no sharing request is received in Step 701, the method loops back and performs Step 701, repeatedly until a sharing request is received.

If the second portable terminal 109 proceeds to Step 703, the second portable terminal 109 transmits the content information sharing request message for requesting the specific content information to the first portable terminal 107, and proceeds to Step 705.

In Step 705, in response to the content information sharing request message, the second portable terminal 109 receives content information with regard to the specific content from the first portable terminal 107, and proceeds to Step 707.

In Step 707, the second portable terminal 109 generates, changes, and/or updates the content shared frequency information indicating that the specific content information is shared, and transmits the generated content shared frequency information to the content information registration server 105. Here, the content shared frequency information may include an ID of the second portable terminal 109 and a content ID of the specific content.

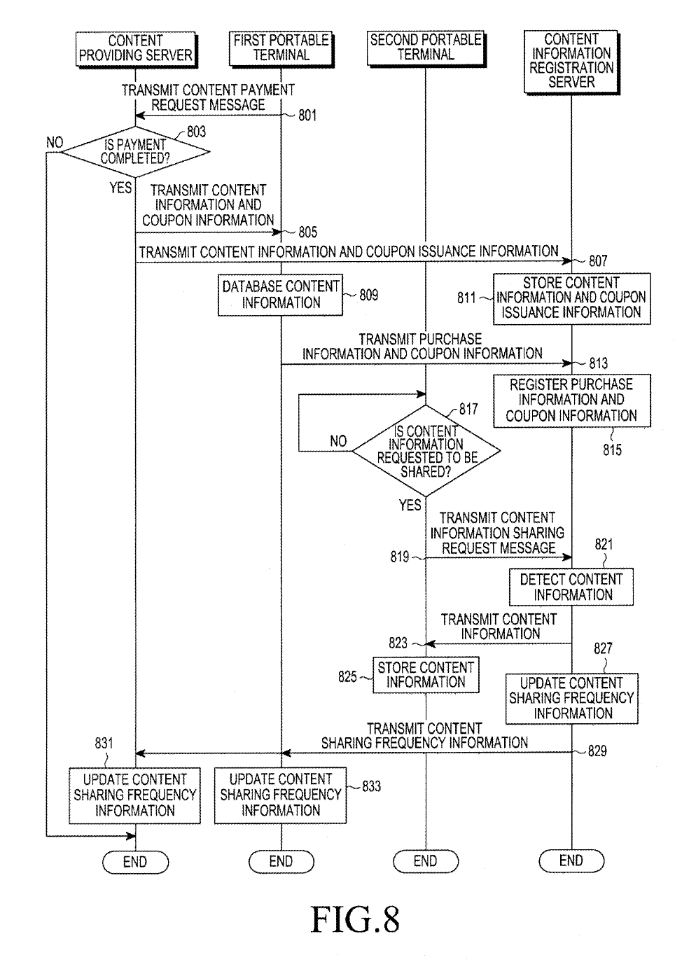

FIG. 8 is a flowchart illustrating a process in which the content information is shared among portable terminals according to the second exemplary embodiment of the present invention. In addition, FIG. 8 is a flowchart illustrating the second way for indirectly sharing the specific content information between the first portable terminal 107 and the second portable terminal 109.

With reference to FIG. 8, in Step 801, the payment of the specific content is requested by the user, and then the first portable terminal 107 transmits the content payment request message to the content providing server 101, and proceeds to Step 803.

In Step 803, the content providing server 101 confirms whether the payment of the specific content is completed. If the payment of the specific content is completed, the content providing server 101 proceeds to Step 805, or otherwise the content sharing process ends.

If the content providing server 101 proceeds to Step 805, the content providing server 101 transmits the content information and the coupon information to the first portable terminal 107, and proceeds to Step 807. In more detail, the content providing server 101 detects the content information with regard to the paid specific content among the content information stored in advance, detects the coupon information corresponding to the paid specific content among the coupon information stored in advance, and transmits the content information to the first portable terminal 107.

In Step 807, the content providing server 101 transmits the coupon issuance information indicating that the detected content information and the detected coupon information is transmitted to the content information registration server 105, and proceeds to Step 809. Here, the coupon issuance information may include an ID and a type of the detected coupon.

In Step 809, the first portable terminal 107 databases the received content information in consideration of a content type of the specific content, manufacturer information, seller information, a purchase date, a purchase price, a use frequency, a sharing frequency, and a current use. In Step 811, the content information registration server 105 stores the content information and the coupon issuance information with regard to the specific content.

In Step 813, the first portable terminal 107 generates purchase information with regard to the specific content using the payment information of the specific content, transmits the generated purchase information and the coupon information with regard to the specific content to the content information registration server 105, and proceeds to Step 815. Here, the payment information may include the purchase date and the purchase type of the specific content. In Step 815, the content information registration server 105 may receive the purchase information and the coupon information, registers the received purchase information and coupon information, and proceeds to Step 817.

When the content information registration server 105 proceeds to Step 817, the second portable terminal 109 confirms whether the sharing of the specific content information is requested by the user of the second portable terminal 109. Resulting from the confirmation, if the sharing is requested, the second portable terminal 109 proceeds to Step 819, or otherwise, if no sharing request is received, the second portable terminal 109 loops back and performs Step 817, repeatedly until a sharing request is received.

If the second portable terminal 109 proceeds to Step 819, the second portable terminal 109 transmits the content information sharing request message for requesting the specific content information to the content information registration server 105, and proceeds to Step 821.

In Step 821, the content information registration server 105 detects the content information with regard to the specific information among the content information stored in advance, and proceeds to Step 823. In Step 823, the content information registration server 105 transmits the detected content information to the second portable terminal 109.

In Step 825, the second portable terminal 109 receives the content information, and stores the received content information. In Step 827, the content information registration server 105 updates content sharing frequency information that includes the number of times of sharing with regard to the specific content information, and proceeds to Step 829.

In Step 829, the content information registration server 105 transmits the content sharing frequency information to the content providing server 101 and the first portable terminal 107, and proceeds to Step 831. In Step 831, the content providing server 101 receives the content sharing frequency information, and updates the number of times of sharing with regard to the specific content using the received content sharing frequency information.

In Step 833, the first portable terminal 107 receives content sharing frequency information, and updates the number of times of sharing with regard to the specific content using the received content sharing frequency information.

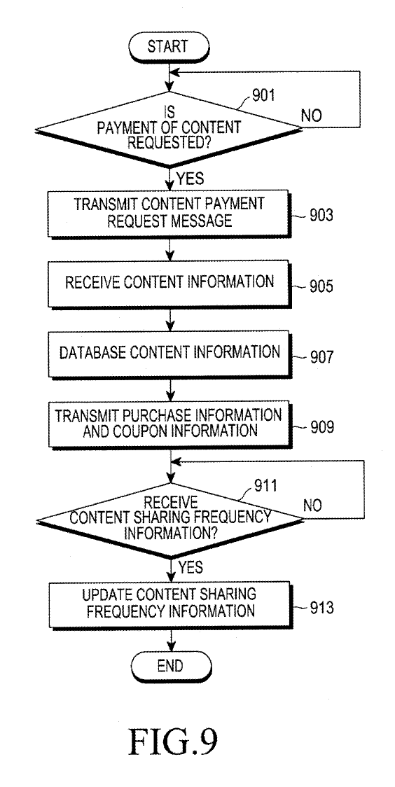

FIG. 9 is a flowchart illustrating a process in which the first portable terminal shares the content information according to the second exemplary embodiment of the present invention. In particular, FIG. 9 is a flowchart illustrating the second way for indirectly sharing the specific content information between the first portable terminal 107 and the second portable terminal 109.

With reference to FIG. 9, in Step 901, the first portable terminal 107 confirms whether the payment of the specific content is requested by the user. Resulting from the request, if the payment is requested, the first portable terminal 107 proceeds to Step 903, or otherwise if no payment request is received in Step 901, the method loops back and performs Step 901, repeatedly until a payment request is received.

If the first portable terminal 107 proceeds to Step 903, the first portable terminal 107 transmits the content payment request message to the content providing server 101, and proceeds to Step 905. In Step 905, in response to the content payment request message, the first portable terminal 107 receives the content information and the coupon information with regard to the specific content, and proceeds to Step 907.

In Step 907, the first portable terminal 107 databases the received content information in consideration of a content type of the specific content, manufacturer information, seller information, a purchase date, a purchase price, a use frequency, a sharing frequency, and a current use, and proceeds to Step 909.

In Step 909, the first portable terminal 107 generates the purchase information with regard to the specific content using the payment information of the specific content, transmits the generated purchase information and the coupon information with regard to the specific content to the content information registration server 105, and proceeds to Step 911.

In Step 911, the first portable terminal 107 confirms whether the content sharing frequency information that includes the number of times of sharing with regard to the specific content is received from the content information registration server 105. If the content sharing frequency information is received, the first portable terminal 107 proceeds to Step 913, or otherwise if no content sharing frequency information is received in step 911, the method loops back and performs Step 911, repeatedly until such information is received.

If the first portable terminal 107 proceeds to Step 913, the first portable terminal 107 updates the number of times of sharing with regard to the specific content using the received content sharing frequency information.

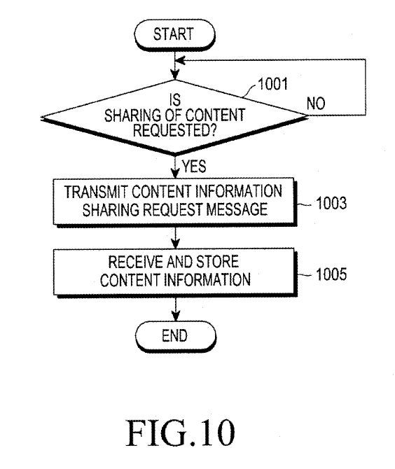

FIG. 10 is a flowchart illustrating a process in which the second portable terminal shares the content information according to the second exemplary embodiment of the present invention. In particular, FIG. 10 is a flowchart illustrating the second way for indirectly sharing the specific content information between the first portable terminal 107 and the second portable terminal 109.

With reference to FIG. 10, in Step 1001, the second portable terminal 109 confirms whether the sharing of the specific content information is requested by the user of the second portable terminal 109. Resulting from the confirmation, if the sharing is requested, the second portable terminal 109 proceeds to Step 1003, or otherwise if no sharing is requested, the method loops back and performs Step 1001, repeatedly until sharing is requested.

If the second portable terminal 109 proceeds to Step 1003, the second portable terminal 109 transmits the content information sharing request message for requesting the specific content information to the content information registration server 105, and proceeds to Step 1005.

In Step 1005, in response to the content information sharing request message, the second portable terminal 109 receives the content information with regard to the specific content from the content information registration server 105, and stores the received content information.

According to these steps, the present invention provides an effective method for enhancing the efficiency of the content advertisement by sharing the content information among portable terminals.

The content provider who manages the content providing server 101 may grasp the market trends and the consumer propensity with regard to the specific content by using the content sharing frequency information with regard to the specific content. In addition, the content provider provides the content information to the portable terminal so that the content provider can be advertised.

The content purchaser who uses the first portable terminal 107 may receive material compensation, awareness is increased according to the number of times of sharing the specific content information, and the specific content becomes popular in a manner similar to a pop star owing to the increased awareness.

The content sharing requester who uses the second portable terminal 109 may purchase a desired content after looking at the desired content directly. Due to the providing of the content information sharing service, the content manager who provides the content information registration server 105 may secure subscribers and receive an advertisement rate.

The present invention provides an effective method of enhancing the efficiency of the content advertisement by sharing content information among portable terminals.

The above-described apparatus and methods according to the present invention can be implemented in hardware, firmware or as software or computer code that can be stored in a non-transitory recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any media such as communication signals transmitted by wire/wireless connections, and their equivalents. The computer readable recording medium can also be distributed in network coupled computer systems so that the computer readable code is stored and executed in a distributed fashion.

While the present invention has been shown and described with reference to certain embodiments such as mobile communication terminals, it will be understood by those skilled in the art that various changes in form and details may be made therein without departing from the spirit and scope of the present invention as defined by the appended claims.

What is claimed is:

1. A system for sharing content information in a communication system, the system comprising:
a content providing server that transmits the content information to a first portable terminal and a content information registration server, when a content payment request message with regard to a specific content is received from the first portable terminal;
wherein the first portable terminal transmits the content payment request message according to a payment request, receives the content information from a second portable terminal in response to the content payment request message, databases the received content information, detects the content information among the databased content information when a content sharing request message with regard to the second portable terminal is received, and transmits the detected content information to the second portable terminal; and
wherein the second portable terminal transmits the content sharing request message to the first portable terminal if a wireless communication with the first portable terminal is available, and receives and stores the content information in response to the content sharing request message.

2. The system for sharing content information according to claim 1, wherein the first portable terminal transmits content sharing frequency information including the number of times of sharing with regard to the specific content to the content information registration server,
wherein the content information registration server updates the number of times of sharing based on the content sharing frequency information, and transmits the content sharing frequency information to the content providing server, and
wherein the content providing server updates the number of times of sharing based on the content sharing frequency information.

3. The system for sharing content information according to claim 1, wherein the content information registration server receives and stores the content information, detects the received content information among pre-existing content information stored in advance when the content sharing request message is received from the second portable terminal, and transmits the detected content information to the second portable terminal, and
wherein the second portable terminal transmits the content sharing request message to the content information registration server when the wireless communication with the first portable terminal is not available, and receives and stores the content information in response to the content sharing request message.

4. The system for sharing content information according to claim 3, wherein the content information registration server transmits the content sharing frequency information including the number of times of sharing with regard to the specific content to the first portable terminal and the content providing server, and
wherein each of the first portable terminal and the content providing server receives the content sharing frequency information, and updates the number of times of sharing based on the content sharing frequency information.

5. The system for sharing content information according to claim 1, wherein the content information includes an ID and a type of the specific content, an ID of a company who manufactures the specific content, an ID of a seller who sells the specific content, and other content information, which is other information with regard to the specific content.

6. An apparatus for sharing content information in a communication system, the apparatus comprising:
a memory unit; and
a controller that transmits a content payment request message to a content providing server when a payment of a specific content is requested, receives content information with regard to the specific content in response to the content payment request message, databases the received content information, and detects the content information among the databased content information, when a wireless communication with a second portable terminal is available, if a content sharing request message with regard to the specific content is received from the second portable terminal.

7. The apparatus for sharing content information according to claim 6, wherein the controller transmits content sharing frequency information including the number of times of sharing with respect to the specific content to the content information registration server.

8. The apparatus for sharing content information according to claim 6, wherein the controller receives content sharing frequency information including the number of times of sharing with regard to the specific content from the second portable terminal when the wireless communication is not available, and updates the number of times of sharing based on the content sharing frequency information.

9. The apparatus for sharing content information according to claim 6, wherein the content information includes an ID and a type of the specific content, an ID of a company who manufactures the specific content, an ID of a seller who sells the specific content, and other content information, which is other information with regard to the specific content.

10. An apparatus for sharing content information in a communication system, the apparatus comprising:
a memory unit, and
a controller transmits a first content sharing request message to a first portable terminal, when a wireless communication with the first portable terminal that stores databased content information is available, if sharing of the content information with regard to a specific content is requested, and receives and stores the content information in response to the first content sharing request message.

11. The apparatus for sharing content information according to claim 10, wherein the controller transmits the content sharing request message to a content information registration server that stores the content information, if the wireless communication is not available, and receives and stores the content information in response to the content sharing request message.

12. The apparatus for sharing content information according to claim 10, wherein the content information includes an ID and a type of the specific content, an ID of a company who manufactures the specific content, an ID of a seller who sells the specific content, and other content information, which is other information with regard to the specific content.

13. A method for sharing content information in a communication system, the method comprising:
transmitting a content payment request message to a content providing server, if a payment of a specific content is requested from a first portable terminal;
transmitting content information with regard to the specific content in response to the content payment request message to the first portable terminal and a content information registration server;
receiving the content information and databasing the received content information;
transmitting a content sharing message with regard to the specific content to the first portable terminal, if a wireless communication with the first portable terminal is available;
detecting the content information among the databased content information and transmitting the detected content information to a second portable terminal, when the content sharing request message is received; and
receiving and storing the content information in response to the content sharing request message.

14. The method for sharing content information according to claim 13, the method further comprising:
transmitting the content sharing frequency information including a number of times of sharing with regard to the specific content to the content information registration server;
receiving the content sharing frequency information, updating the number of times of sharing based on the content sharing frequency information, and transmitting the content sharing frequency information to the content providing server, and
receiving the content sharing frequency information, and updating the number of times of sharing based on the content sharing frequency information.

15. The method for sharing content information according to claim 13, the method further comprising:
receiving and storing the content information from the content providing server;
transmitting the content sharing request message to the content information registration server, when the wireless communication with the first portable terminal is not available;
detecting the content information among content information stored in advance and transmitting the detected content information to the second portable terminal, when the content sharing request message is received from the second portable terminal; and
receiving and storing the content information in response to the content sharing request message.

16. The method for sharing content information according to claim 15, the method further comprising:
transmitting content sharing frequency information including the number of times of sharing with regard to the specific content to the first portable terminal and the content providing server; and
receiving the content sharing frequency information, and updating the number of times of sharing based on the content sharing frequency information.

17. The method for sharing content information according to claim 13, wherein the content information includes an ID and a type of the specific content, an ID of a company who manufactures the specific content, an ID of a seller who sells the specific content, and other content information, which is other information with regard to the specific content.

18. A method for sharing the content information in the communication system, the method comprising:
transmitting a content payment request message to a content providing server, when a payment of a specific content is requested;
databasing the received content information in response to the content payment request message and receiving content information with regard to the specific content;
detecting the content information among the databased content information and transmitting the detected content information, if a wireless communication with a second portable terminal is available, if a content sharing request message with regard to the specific content from the second portable terminal is received.

19. The method for sharing the content information according to claim 18, the method further comprising:
transmitting content sharing frequency information including the number of times of sharing with regard to the specific content to the content information registration server.

20. The method for sharing the content information according to claim 18, the method further comprising:
receiving content sharing frequency information including the number of times of sharing with regard to the specific content from the content information registration server; and
updating the number of times of sharing with regard to the specific content based on the content sharing frequency information.

21. The method for sharing the content information according to claim 18, wherein the content information includes an ID and a type of the specific content, an ID of a company who manufactures the specific content, an ID of a seller who sells the specific content, and other content information, which is other information with regard to the specific content.

22. A method for sharing content information in a communication system, the method comprising:
transmitting a content sharing request message to a first portable terminal, when a wireless communication with a first portable terminal that stores databased content information is available, when sharing of content information with regard to a specific content is requested; and
receiving and storing the content information in response to the first content sharing request message.

23. The method for sharing content information according to claim 22, the method further comprising:
transmitting the content sharing request message to a content information registration server that stores the content information, when the wireless communication is not available; and
receiving and storing the content information in response to the content sharing request message.

24. The method for sharing the content information according to claim 22, wherein the content information includes an ID and a type of the specific content, an ID of a company who manufactures the specific content, an ID of a seller who sells the specific content, and other content information, which is other information with regard to the specific content.
